(19) United States
(12) Patent Application Publication
(10) Pub. No.: US 2021/0166234 A1
(43) Pub. Date: Jun. 3, 2021

(54) MULTI-DEVICE AUTHENTICATION

(71) Applicant: Wells Fargo Bank, N.A., San Francisco, CA (US)

(72) Inventors: Jared Stanley Anderson, Minneapolis, MN (US); Carolee Ann-Eckert Peterson, Brooklyn Park, MN (US); Jane Hollis, Coon Rapids, MN (US); Jennifer Lynn Struzyk, Columbia Heights, MN (US); Mary Louise Hurd, Coon Rapids, MN (US)

(21) Appl. No.: 15/391,677

(22) Filed: Dec. 27, 2016

(51) Int. Cl. G06Q 20/40

(52) U.S. Cl. CPC G06Q 20/405

(57) ABSTRACT

Systems and methods are disclosed for multi-device authentication. In one implementation, a transaction request initiated with respect to a first device and a second device is received, each of the first device and the second device being associated with a user account. One or more transaction completion criteria associated with the user account are identified. A determination is made as to whether the one or more transaction completion criteria associated with the user account are met with respect to the first device, the second device, and the transaction request. Based on a determination that the one or more transaction completion criteria associated with the user account are met with respect to the first device, the second device, and the transaction request, the transaction request is completed.

### TECHNICAL FIELD

Aspects and implementations of the present disclosure relate to data processing, and more specifically, to multi-device authentication.

### BACKGROUND

Unique user accounts can be generated and issued to respective users. Such user accounts can be associated with one or more devices, and such device(s) can be used to initiate or authorize various operations. Accordingly, it can be important to maintain the security of the device(s) in order to prevent its unauthorized use of the associated user account.

### BRIEF DESCRIPTION OF THE DRAWINGS

Aspects and implementations of the present disclosure will be understood more fully from the detailed description given below and from the accompanying drawings of various aspects and implementations of the disclosure, which, however, should not be taken to limit the disclosure to the specific aspects or implementations, but are for explanation and understanding only.

FIG. 1 depicts an illustrative system architecture, in accordance with one implementation of the present disclosure.

FIG. 2 depicts an exemplary implementation of a device in accordance with aspects and implementations of the present disclosure.

FIG. 3 depicts a flow diagram of aspects of a method for multi-device authentication in accordance with one implementation of the present disclosure.

FIG. 4 depicts a block diagram of an illustrative computer system operating in accordance with aspects and implementations of the present disclosure.

### DETAILED DESCRIPTION

Aspects and implementations of the present disclosure are directed to multi-device authentication.

It can be appreciated that a unique user account (such as can be generated/issued by an institution) can enable a user to initiate or authorize various operations, transactions, etc. However, in certain scenarios it may not be convenient or possible to provide/present information pertaining to the user account itself. Additionally, it can be appreciated that certain devices (e.g., wearable devices such as fitness trackers, smartwatches, and/or any other such connected devices) may regularly be present with respect to a particular user (e.g., a user that is authorized to initiate operations, transactions, etc., with respect to a user account). As such, detecting the presence of these device(s) can provide a relatively high degree of certainty that the user associated with the user account is actually present (as opposed to another user who is not authorized to utilize the user account).

Accordingly, described herein in various implementations are technologies, including methods, machine readable mediums, and systems, that enable multi-device authentication. For example, various devices (e.g., multiple wearable devices) can be associated with a user account. An operation (e.g., a transaction) can then be initiated with respect to such device(s). For example, in lieu of (or in addition to) providing information pertaining to the user account itself, such device(s) can be presented, provided, and/or otherwise made perceptible to a terminal (e.g., a terminal at which such an operation/transaction is being initiated). Upon determination that the presented/perceived devices are associated with the user account, the referenced operation/transaction can be approved.

Additionally, in certain implementations various criteria can be defined which dictate various conditions/requirements to be met in order for an operation/transaction to be approved, as described herein. In doing so, various secure operations and/or transactions can be executed with respect to a user account, even in scenarios in which information pertaining to the user account itself is not provided. As a result, secure operations and transactions can be initiated and executed in a more convenient and natural fashion (e.g., using device(s) that are already frequently worn or carried by a user), while also preventing approval of unauthorized attempts.

Accordingly, it can be appreciated that the described technologies are directed to and address specific technical challenges and longstanding deficiencies in multiple technical areas, including but not limited to security, account management, device authentication, and wearable devices/communication technologies. As described in detail herein, the disclosed technologies provide specific, technical solutions to the referenced technical challenges and unmet needs in the referenced technical fields and provide numerous advantages and improvements upon conventional approaches. Additionally, in various implementations one or more of the hardware elements, components, etc., (e.g., sensors, devices, etc.) referenced herein operate to enable, improve, and/or enhance the described technologies, such as in a manner described herein.

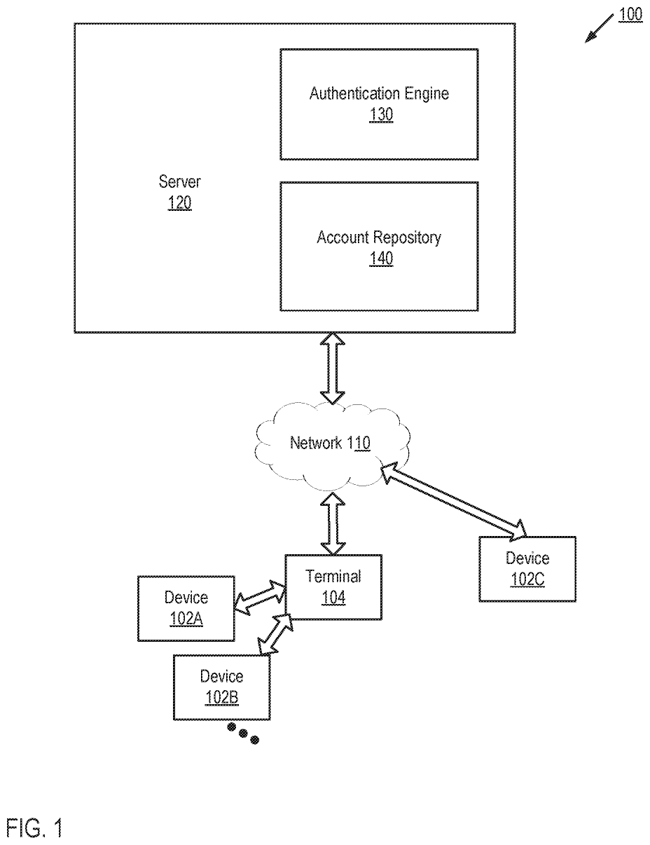

FIG. 1 depicts an illustrative system architecture 100, in accordance with one implementation of the present disclosure. The system architecture 100 includes one or more devices 102A-C, terminal 104, and server 120. These various elements or components can be connected to one another via network 110, which can be a public network (e.g., the Internet), a private network (e.g., a local area network (LAN) or wide area network (WAN)), or a combination thereof. Additionally, in certain implementations various elements can communicate and/or otherwise interface with one another device 102A with terminal 104).

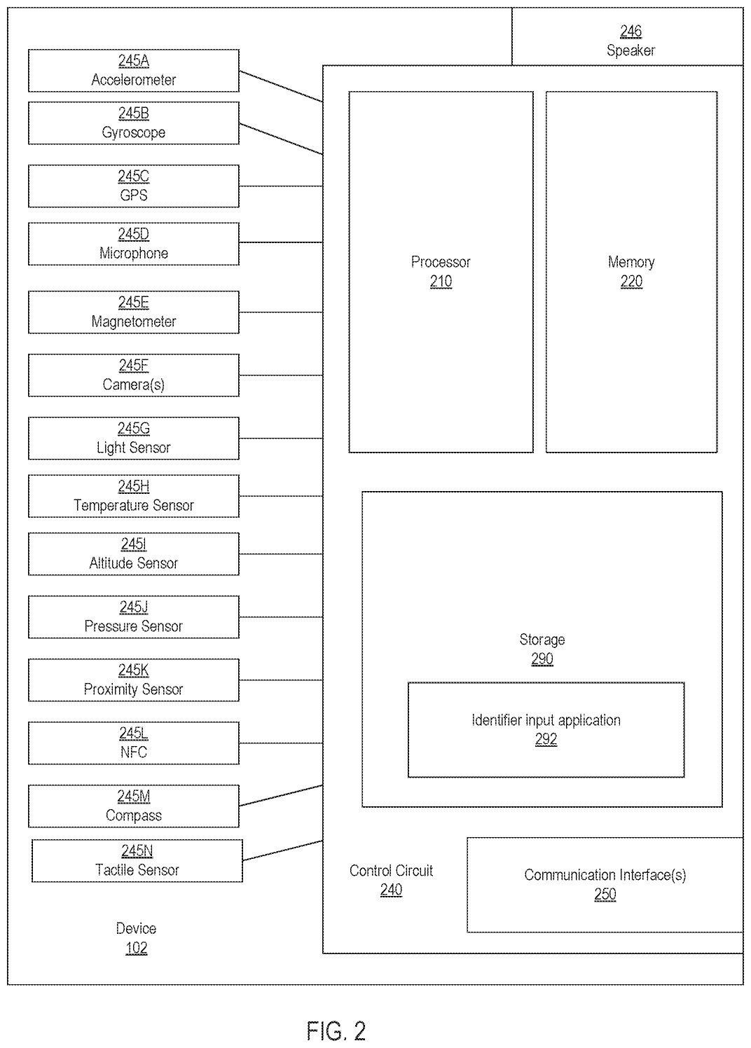

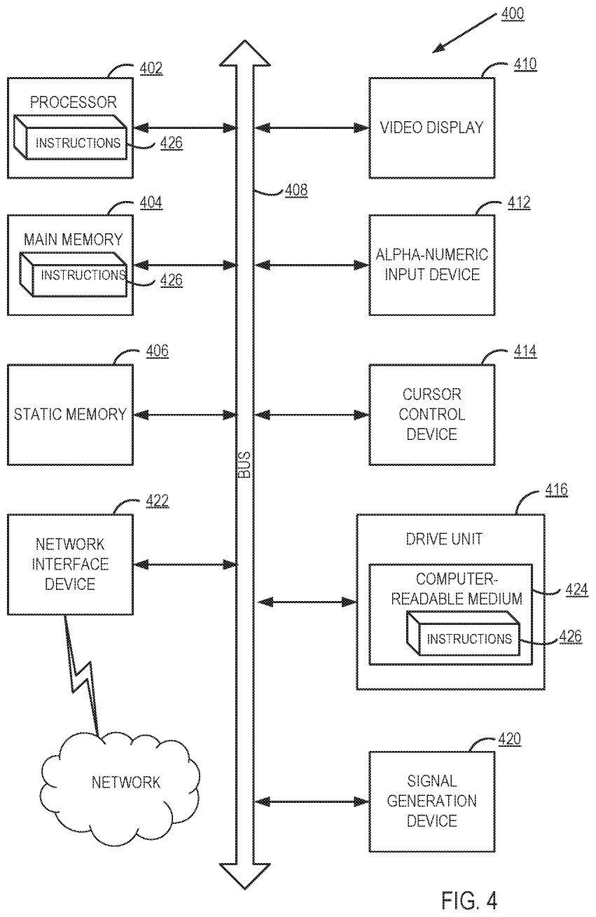

Each device 102 can be a wearable device (e.g., a portable electronic device or component that includes one or more sensors, communication interfaces, etc., such as a fitness tracker), a mobile phone, a smartphone, a watch, a smartwatch, a rackmount server, a router computer, a personal computer, a portable digital assistant, a laptop computer, a tablet computer, a camera, a video camera, a netbook, a desktop computer, a media center, an in-vehicle computer/system, any combination of the above, or any other such device capable of implementing the various features described herein. In certain implementations, various applications, such as mobile applications (‘apps’), web browsers, etc. can run on the device (e.g., on the operating system of the device). It should be understood that, in certain implementations, device 102 can also include and/or incorporate various sensors and/or communications interfaces (including but not limited to those depicted in FIGS. 2 and 4 and/or described/referenced herein). Examples of such sensors include but are not limited to: accelerometer, gyroscope, compass, GPS, haptic sensors (e.g., touchscreen, buttons, etc.), microphone, camera, etc. Examples of such communication interfaces include but are not limited to cellular (e.g., 3G, 4G, etc.) interface(s), Bluetooth interface, WiFi interface, USB interface, NFC interface, etc. It should also be noted that, in certain implementations, device 102 can be a device that does not incorporate electronics, sensors, etc. For example, in certain implementations a ring, necklace, jewelry, and/or any other such physical element can serve as a device as described herein, e.g., in order to authenticate a transaction with respect to a user account in conjunction with the described technologies.

As noted, in certain implementations, device(s) 102 can also include and/or incorporate various sensors and/or communications interfaces. By way of illustration, FIG. 2 depicts one exemplary implementation of device 102. As shown in FIG. 2, device 102 can include a control circuit 240 (e.g., a motherboard) which is operatively connected to various hardware and/or software components that serve to enable various operations, such as those described herein. Control circuit 240 can be operatively connected to processor 210 and memory 220. Processor 210 serves to execute instructions for software that can be loaded into memory 220. Processor 210 can be a number of processors, a multi-processor core, or some other type of processor, depending on the particular implementation. Further, processor 210 can be implemented using a number of heterogeneous processor systems in which a main processor is present with secondary processors on a single chip, As another illustrative example, processor 210 can be a symmetric multi-processor system containing multiple processors of the same type.

Memory 220 and/or storage 290 can be accessible by processor 210, thereby enabling processor 210 to receive and execute instructions stored on memory 220 and/or on storage 290. Memory 220 can be, for example, a random access memory (RAM) or any other suitable volatile or non-volatile computer readable storage medium, n addition, memory 220 can be fixed or removable. Storage 290 can take various forms, depending on the particular implementation. For example, storage 290 can contain one or more components or devices. For example, storage 290 can be a hard drive, a flash memory, a rewritable optical disk, a rewritable magnetic tape, or some combination of the above.

As shown in FIG. 2, storage 290 can store identifier input application 292. In certain implementations, identifier input application 292 can be, for example, instructions, an ‘app,’ etc., that can be loaded into memory 220 and/or executed by processing device 210, in order to enable a user of the device to interact with and/or otherwise utilize the multi-device authentication technologies described herein. For example, as described herein, identifier input application 292 can enable a user to provide various identifier(s) (e.g., a password, PIN, biometric identifier, etc.), e.g., in order to further verify/authenticate that the use of various device(s) in initiating a transaction is authorized.

One or more communication interface(s) 250 are also operatively connected to control circuit 240. The various communication interface(s) 250 can include interfaces that enable communication between device 102 and one or more external devices, machines, services, systems, and/or elements (including but not limited to those depicted in FIG. 1 and described herein). Communication interface(s) 250 can include (but is not limited to) a modem, a Network Interface Card (MC), an integrated network interface, a radio frequency transmitter/receiver (e.g., Bluetooth, cellular, NFC), a satellite communication transmitter/receiver, an infrared port, a USB connection, or any other such interfaces for connecting device 102 to other computing devices, systems, services, and/or communication networks such as the Internet. Such connections can include a wired connection or a wireless connection (e.g. 802.11) though it should be understood that communication interface 250 can be practically any interface that enables communication to/from the control circuit 240 and/or the various components described herein.

At various points during the operation of described technologies, device 102 can communicate with one or more other devices, systems, services, servers, etc., such as those depicted in FIG. 1 and/or described herein. Such devices, systems, services, servers, etc., can transmit and/or receive data to/from the device 102, thereby enhancing the operation of the described technologies, such as is described in detail herein. It should be understood that the referenced devices, systems, services, servers, etc., can be in direct communication with device 102, indirect communication with device 102, constant/ongoing communication with device 102, periodic communication with device 102, and/or can be communicatively coordinated with device 102, as described herein.

Also connected to and/or in communication with control circuit 240 of device 102 are one or more sensors 245A-245N (collectively, sensors 245). Sensors 245 can be various components, devices, and/or receivers that can be incorporated/integrated within and/or in communication with device 102. Sensors 245 can be configured to detect one or more stimuli, phenomena, or any other such inputs, described herein. Examples of such sensors 245 include, but are not limited to, an accelerometer 245A, a gyroscope 245B, a GPS receiver 245C, a microphone 245D, a magnetometer 245E, a camera 245F, a light sensor 245G, a temperature sensor 245H, an altitude sensor 245I, a pressure sensor 245J, a proximity sensor 245K, a near-field communication (NFC) device 245L, a compass 245M, and a tactile sensor 245N. As described herein, device 102 can perceive/receive various inputs from sensors 245 and such inputs can be used to initiate, enable, and/or enhance various operations and/or aspects thereof, such as is described herein.

At this juncture it should be noted that while the foregoing description (e.g., with respect to sensors 245) has been directed to device(s) 102, various other devices, systems, servers, services, etc. (such as are depicted in FIG. 1 and/or described herein) can similarly incorporate the components, elements, and/or capabilities described with respect to device 102. For example, terminal 104 can also incorporate one or more of the referenced components, elements, and/or capabilities. It should also be understood that certain aspects and implementations of various devices, systems, servers, services, etc., such as those depicted in FIG. 1 and/or described herein, are also described in greater detail below in relation to FIG. 4.

Terminal 104 can be a point of sale (POS) system, device and/or terminal, a rackmount server, a router computer, a personal computer, a portable digital assistant, a mobile phone, a laptop computer, a tablet computer, a camera, a video camera, a netbook, a desktop computer, a media center, a smartphone, a watch, a smartwatch, an in-vehicle computer/system, any combination of the above, or any other such computing device capable of implementing the various features described herein. Various applications, such as mobile applications (‘apps’), web browsers, etc. (not shown) can run on the terminal (e.g., on the operating system of the terminal). It should be understood that, in certain implementations, terminal 104 can also include and/or incorporate various sensors and/or communications interfaces (including but not limited to those depicted in FIG. 2 and described in relation to device 102). Examples of such sensors include but are not limited to: accelerometer, gyroscope, compass, GPS, haptic sensors (e.g., touchscreen, buttons, etc.), microphone, camera, barcode scanner, etc. Examples of such communication interfaces include but are not limited to cellular (e.g., 3G, 4G, etc.) interface(s), Bluetooth interface, WiFi interface, USB interface, NFC interface, etc.

Server 120 can be a rackmount server, a router computer, a personal computer, a portable digital assistant, a mobile phone, a laptop computer, a tablet computer, a camera, a video camera, a netbook, a desktop computer, a smartphone, a media center, a smartwatch, an in-vehicle computer/system, any combination of the above, or any other such computing device capable of implementing the various features described herein. Server 120 can include components such as authentication engine 130, and account repository 140. It should be understood that, in certain implementations, server 120 can also include and/or incorporate various sensors and/or communications interfaces (including but not limited to those depicted in FIG. 2 and described in relation to device 102). The components can be combined together or separated in further components, according to a particular implementation. It should be noted that in some implementations, various components of server 120 can run on separate machines (for example, account repository 140 can be a separate device). Moreover, some operations of certain of the components are described in more detail below.

Account repository 140 can be hosted by one or more storage devices, such as main memory, magnetic or optical storage based disks, tapes or hard drives, NAS, SAN, and so forth. In some implementations, account repository 140 can be a network-attached file server, while in other implementations account repository 140 can be some other type of persistent storage such as an object-oriented database, a relational database, and so forth, that can be hosted by the server 120 or one or more different machines coupled to the server 120 via the network 110, while in yet other implementations account repository 140 can be a database that is hosted by another entity and made accessible to server 120. Account repository 140 can store information relating to various user accounts (e.g., credit cards, bank accounts, etc.), such as account numbers, balances, usage history, and/or any other such related information/parameters, such as may be maintained by a bank, financial institution, etc. Additionally, as described herein, in certain implementations various device(s) can be associated with a user account (or user accounts) stored in account repository 140, and an International Mobile Equipment identity (IMEI) number and/or a Mobile Equipment Identifier (MEID) associated with such devices (and/or any other such identifying information, e.g., a photograph/image in the case of a device that is not electronic/connected) can also be stored in account repository 140 (e.g., in relation to the associated user account(s)). Moreover, as also described herein, in certain implementations various transaction completion criteria can be associated with a user account (or user accounts) stored in account repository 140. Such transaction completion criteria can define/dictate various conditions/requirements to be met in order for a transaction request to be approved, as described herein.

It should be understood that though FIG. 1 depicts server 120, devices 102, and terminal 104 as being discrete components, in various implementations any number of such components (and/or elements/functions thereof) can be combined, such as within a single component/system. For example, in certain implementations device(s) 102 and/or terminal 104 can incorporate features of server 120.

As described in detail herein, various technologies are disclosed that enable multi-device authentication. In certain implementations, such technologies can encompass operations performed by and/or in conjunction with server 120, terminal 104, and/or device(s) 102.

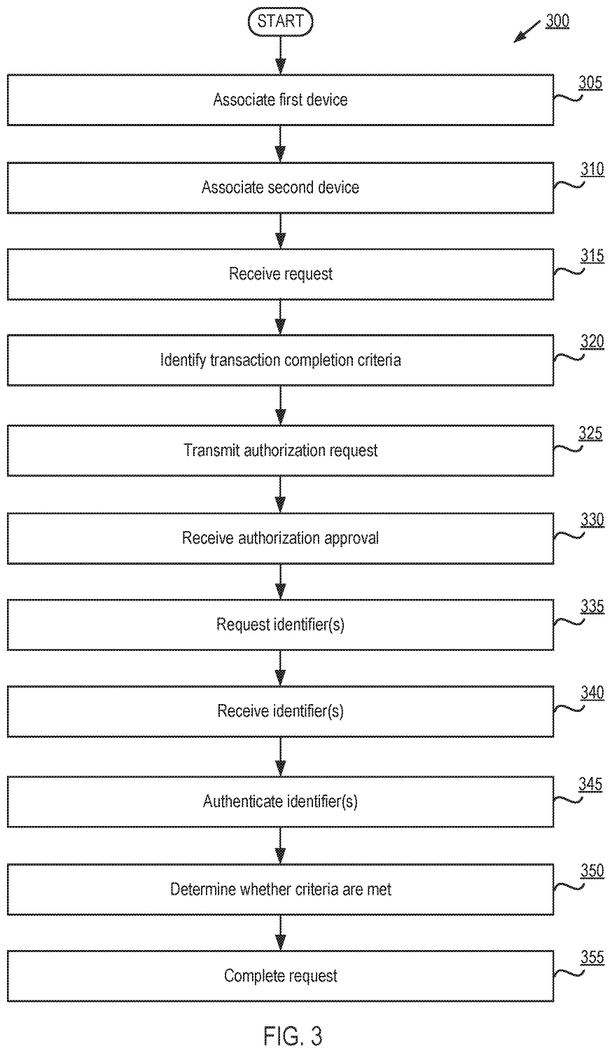

FIG. 3 depicts a flow diagram of aspects of a method 300 for multi-device authentication. The method is performed by processing logic that can comprise hardware (circuitry, dedicated logic, etc.), software (such as is run on a computing device such as those described herein), or a combination of both. In one implementation, the method is performed by one or more elements depicted and/or described in relation to FIG. 1 (including but not limited to server 120, authentication engine 130, terminal 140, and/or device(s) 102) and/or FIG. 2 (e.g., identifier input application 292 and/or device 102), while in some other implementations, one or more blocks of FIG. 3 can be performed by another machine or machines.

For simplicity of explanation, methods are depicted and described as a series of acts. However, acts in accordance with this disclosure can occur in various orders and/or concurrently, and with other acts not presented and described herein. Furthermore, not all illustrated acts may be required to implement the methods in accordance with the disclosed subject matter. In addition, those skilled in the art will understand and appreciate that the methods could alternatively be represented as a series of interrelated states via a state diagram or events. Additionally, it should be appreciated that the methods disclosed in this specification are capable of being stored on an article of manufacture to facilitate transporting and transferring such methods to computing devices. The term article of manufacture, as used herein, is intended to encompass a computer program accessible from any computer-readable device or storage media.

At block 305, a first device can be associated with a user account. For example, as shown in FIG. 1, device 102A which can be, for example, a wearable device(e.g., a fitness tracker, Bluetooth headset, etc.), music player, smartphone, etc., can be associated with a user account such as a credit card number, bank account, etc. (such as may be managed/maintained by a financial institution, bank, etc. and stored in account repository 140 of server 120). In certain implementations, a user can utilize an application (e.g., a mobile app), webpage, etc., to associate the device with the user account, as well as to manage such association (e.g., to define transaction completion criteria with respect to the device, to revoke an association between a device and a user account, etc., as described herein). The application may also be used for further user input in other acts described with respect to FIG. 3. By way of illustration, an IMEI number and/or a MEID of a device (or any other such device identifier) can be associated with a user account, (e.g., credit card number, etc.), and such association can be stored, e.g., with respect to the user account (credit card number, bank account, etc.) in account repository 140 of server 120. It should be understood that, in certain implementations, various aspects of block 305 can be performed by server 120, authentication engine 130 and/or account repository 140, while in other implementations such aspects can be performed by terminal 104 and/or one or more other elements/components, such as those described herein.

At block 310, a second device can be associated with a user account (e.g., the user account with respect to which the first device was associated at block 305). As described in relation to block 305, a device (wearable device, mobile device, physical/static device, e.g. a ring, jewelry, etc.) can be associated with the user account (credit card number, bank account, etc.) that the first device was associated with at block 305. By way of illustration, one or more images, pictures, etc., of a ring, necklace, etc., can be captured and/or otherwise provided/received, and such images can be can be associated with the user account (e.g., credit card number, etc.) referenced above at block 305. Such association can also be stored with respect to the user account in account repository 140 of server 120. It should be understood that, in certain implementations, various aspects of block 310 can be performed by server 120, authentication engine 130 and/or account repository 140, while in other implementations such aspects can be performed by terminal 104 and/or one or more other elements/components, such as those described herein.

At block 315, a transaction request can be received. In certain implementations, such a transaction requested can be initiated with respect to a first device (e.g., the device referenced at block 305) and/or a second device (e.g., the device referenced at block 310). Such a transaction request can be, for example, an attempt to initiate a purchase, transaction, etc., e.g., at/in relation to a POS terminal (e.g., terminal 104, as shown in FIG. 1). As noted above, in certain implementations both the first device (e.g., device 102A) and the second device (e.g., device 102B) can be associated with a user account (e.g., the same credit card, bank account, etc.). It should be understood that, in certain implementations, various aspects of block 315 can be performed by server 120, authentication engine 130 and/or account repository 140, while in other implementations such aspects can be performed by terminal 104 and/or one or more other elements/components, such as those described herein.

By way of illustration, in order to initiate a purchase at a retail establishment (e.g., a store, etc.), a user can, for example, select various items, services, etc., for purchase. The user can then be prompted (e.g., at terminal 104) to provide payment for such items. In response to such a prompt, the user can present and/or provide one or more devices (and/or otherwise make such device(s) accessible/perceptible), such as devices 102A and 102B (as shown in FIG. 1). For example, the user can approach terminal 104 (e.g., a POS terminal) and (in lieu of providing a credit card or other such means for payment) present devices 102A and 102B (e.g., such that terminal 104 can detect, perceive, etc., the referenced devices). In doing so, the transaction request can be initiated with respect to the first device (e.g., the device referenced at block 305) and/or the second device (e.g., device 102B). Additionally, in certain implementations, the user may also provide one or more inputs, e.g., via terminal 104, and such inputs can be received by terminal 104 and/or server 120. Such inputs can further indicate/specify that the user intends or desires to utilize the first device and/or second device to initiate the referenced transaction request (e.g., in lieu of paying with a credit card, etc.). As noted above, device 102A can be, for example, a fitness tracker, smartphone, etc., which can be perceived/identified by terminal 104 via one or more communication interfaces/protocols, such as NFC, Bluetooth, Radio-frequency identification (RFID), etc. Similarly, in certain implementations device 102B can be another electronic/connected device (e.g., a Bluetooth headset, media player, etc.) which can also be perceived/detected by terminal 104 via various communication interfaces/protocols (Bluetooth, NFC, Wifi, etc.). As noted above, in other implementations device 102B can be a static (e.g., non-electronic/connected device, such as a ring, jewelry, etc.), in which case image(s) of the device can be captured, e.g., at/by terminal 104. Identifying characteristics of such device(s) (e.g., identifying information such as IMEI or MEID in the case of a connected device and/or captured image(s) in the case of a non-connected device) can be combined or otherwise associated with various transaction parameters that can be generated by the terminal 104 (reflecting, for example, the item(s) being purchased, purchase price, identity of the retailer, location of the retailer, time of the purchase, etc.) and can be transmitted to (and received by) server 120 (e.g., in order to request approval of the transaction by the bank, etc. that manages/administers the user account).

At block 320, one or more transaction completion criteria can be identified. Such transaction completion criteria can be associated with the user account (and stored in account repository 140) and can define/dictate various conditions/requirements to be met in order for a transaction request to be approved (e.g., using a user interface presented on user device 102A). For example, the referenced transaction completion criteria can include or otherwise reflect a quantity of devices that are associated with the user account (e.g., credit card, bank account, etc., with respect to which the transaction is directed) that are to be present during initiation of the transaction request. The referenced transaction completion criteria can dictate that at least such a quantity of devices are to be present in order for such a transaction to be approved/completed by the bank, etc., that administers the user account. By way of illustration, a user can define/dictate that at least three devices that have been associated with the user's credit card need to be detected, identified, perceived, etc. (e.g., by terminal 104) in order for a transaction request to be approved. It should be understood that, in certain implementations, various aspects of block 320 can be performed by server 120, authentication engine 130 and/or account repository 140, while in other implementations such aspects can be performed by terminal 104 and/or one or more other elements/components, such as those described herein.

It should also be understood that a user can define any number of transaction completion criteria, e.g., with respect to their user account (credit card number, etc.). For example, such transaction completion criteria can include or otherwise reflect a transaction amount threshold. By way of illustration, such a transaction amount threshold can dictate that only transactions, purchases, etc., up to a defined monetary amount (e.g., $100) can be approved (e.g., if such transactions were initiated via presentation of the referenced device(s) 102 at terminal 104, e.g., in lieu of presenting a credit card, etc.). By way of further illustration, such transaction completion criteria can include or otherwise reflect one or more transaction types. For example, such transaction completion criteria can dictate that only those transactions initiated with respect to a particular store/store type (e.g., a grocery store, gas station, etc.) and/or a particular purchase/item type (e.g., purchase of food, gasoline, clothing, etc.) can be approved (e.g., if such transactions were initiated via presentation of the referenced device(s) 102 at terminal 104, e.g., in lieu of presenting a credit card, etc.).

It should be understood that the referenced transaction completion criteria are exemplary and that any number of criteria can be defined based on any number of variables, factors, etc. It should also be noted that, in certain implementations, such criteria can be defined as a combination or composite of multiple criteria. For example, such transaction completion criteria can dictate/define that transactions of less than $50 can be approved based on the presentation/perception of two devices associated with the user account, while transactions above $50 can be approved based on the presentation/perception of three devices associated with the user account (and such criteria can further dictate that one of such devices must be a smartphone associated with the user account).

Additionally, in certain implementations the referenced transaction completion criteria can dictate/define that, in order for a transaction request to be approved (e.g., a transaction request initiated with respect to devices 102A and 102B) a determination is to be made that the device(s) with respect to which the transaction was initiated (here, devices 102A and 102B) are within a defined geographic proximity, distance, radius, etc. from another device (e.g., device 102C, as shown in FIG. 1).

It can be appreciated that, in certain scenarios, it can be advantageous for a first user (e.g., a parent/guardian) to enable a second user (e.g., a child) to utilize a user account (e.g., credit card, bank account, etc.) associated with the first user (e.g., by utilizing the multi-device transaction initiation/approval technologies, etc., described herein). However, in order to enhance the security of such transactions and/or to reduce the likelihood of fraud/unauthorized transactions (e.g., in a scenario in which the referenced device(s) are lost or stolen), various transaction completion criteria can be defined. Such transaction completion criteria can dictate, for example, that transactions initiated with respect to certain devices (e.g., devices 102A and 102B, which, in this example, can be devices associated with a ‘child’ user) can only be approved upon determining that such ‘child’ devices are within a defined geographic proximity, etc. (e.g., 5 miles), of one or more ‘parent’ devices (e.g., device 102C). In such scenarios, upon receipt of the referenced transaction request (e.g., as initiated by ‘child’ devices 102A and 102B), a location (e.g., geographic coordinates) of another device (e.g., ‘parent’ device 102C) can be requested and/or otherwise determined (e.g., based on inputs originating from a GPS receiver, etc., of the device). The location of such a ‘parent’ device can then be compared to the location of the ‘child’ device(s) in order to determine the distance between the devices and whether or not such distance meets the referenced transaction completion criteria). In doing so, the described technologies can enhance the security of such transactions by ensuring that only those transactions initiated by the ‘child’ that occur within a defined proximity of the ‘parent’ are to be approved, thereby reducing the likelihood that the ‘child’ device(s) may be used for unauthorized purchases (which may be more likely to occur outside such a geographic proximity).

At block 325, an authorization request can be transmitted. In certain implementations, such an authorization request can be a request that another user/party approve the transaction request. For example, in a scenario in which a ‘parent’ enables a ‘child’ to initiate transactions with respect to a user account associated with the parent, upon receiving a transaction request initiated by the child (e.g., with respect to one or more device(s) associated with the child), a notification, request, message, etc., can be generated and transmitted, e.g., to a device associated with the parent. Such an authorization request can provide various information regarding the transaction request (e.g., the time, location, store, items, etc., associated with the transaction) and prompt and/or otherwise provide selectable option(s) for the user (here, the parent user) to approve and/or deny such a transaction. It should be understood that, in certain implementations, various aspects of block 325 can be performed by server 120, authentication engine 130 and/or account repository 140, while in other implementations such aspects can be performed by terminal 104 and/or one or more other elements/components, such as those described herein.

Additionally, in certain implementations such an authorization request can be generated and/or transmitted based on one or more transaction completion criteria (e.g., as identified at block 320). For example, in certain implementations such transaction completion criteria can dictate that transaction requests (e.g., those initiated by a ‘child’) below a certain amount (e.g., below $50) can be approved without additional authorization (e.g., by a ‘parent’), while transaction requests above such an amount (e.g., above $50) require authorization (e.g., by the parent) before being approved. By way of illustration, upon receiving a transaction request initiated with respect to devices 102A and 102B (here, ‘child’ devices) that exceeds a defined purchase threshold (the transaction completion criteria), an authorization request can be generated and transmitted to device 102C (the ‘parent’ device in the present example), requesting authorization to approve the referenced transaction request.

At block 330, authorization approval can be received. In certain implementations, such an authorization approval can be received in response to an authorization request (e.g., the authorization request transmitted at block 325, such as may originate with respect to a transaction initiated by one or more devices, e.g., devices 102A and 102B as shown in FIG. 1). Such an authorization approval can be received from another device (e.g., a device with respect to which the transaction was not initiated, e.g., device 102C as shown in FIG. 1) and can, for example, instruct the bank, institution, etc. that administers the user account (e.g., credit card number, bank account, etc.) with respect to which the transaction was initiated to approve the transaction (e.g., the transaction with respect to which approval was requested). It should be understood that, in certain implementations, various aspects of block 330 can be performed by server 120, authentication engine 130 and/or account repository 140, while in other implementations such aspects can be performed by terminal 104 and/or one or more other elements/components, such as those described herein.

At block 335, one or more identifiers can be requested. Such identifiers, can be, for example, additional information, inputs, etc. (e.g., in addition to the identifying information provided by the device(s) with respect to which the transaction was initiated) that can be used to further verify or authenticate that the device(s) are being used in an authorized manner in initiating the current transaction/request. Examples of such identifiers include but are not limited to: a PIN, password, secret question, phone number, email address, mailing address, social security number or a portion thereof, date of birth, biometric input (fingerprint, retina scan, photograph, voice/audio input, etc.) associated with the user of the device(s), etc. Corresponding identifier(s) (e.g., a PIN, password, etc.) can be previously provided by the user (e.g., upon registering the account) and stored/associated with the user account (e.g., in account repository 140), e.g., in order to enable subsequent verification/authentication, as described herein. Additionally, in certain implementations the referenced identifier(s) (e.g., which identifiers, how many identifiers etc.) can be requested based on various criteria. In doing so, for example, no (or fewer) identifiers may be requested for those transactions that can be determined to be more likely to be authorized, while one (or several) identifiers may be requested for those transactions that can be determined to be more likely to be unauthorized. It should be understood that, in certain implementations, various aspects of block 335 can be performed by server 120, authentication engine 130 and/or account repository 140, while in other implementations such aspects can be performed by terminal 104 and/or one or more other elements/components, such as those described herein.

By way of illustration, in a scenario in which only two devices have been presented/perceived with respect to a transaction request, one or more identifiers (e.g., a PIN, password, fingerprint, etc.) can be requested (and are to be authenticated prior to approving the transaction), on account of the fact that it is possible that the two devices may have been stolen/lost and thus the transaction may be unauthorized (thus, by requesting the referenced identifier(s), it can be determined with greater certainty that the use of the referenced device(s) with respect to the current transaction is authorized). However, in a scenario in which four devices have been presented/perceived with respect to a transaction request, such identifiers may not need to be requested in order to approve the transaction (on account of the fact that, by virtue of four devices that are associated with the user account being presented/perceived, it is already highly unlikely that the transaction is unauthorized, since it is relatively unlikely that all four devices were stolen/lost).

At block 340, one or more identifiers can be received. In certain implementations, such identifiers can be received in response to a request (e.g., at block 335). For example, the user can be prompted (e.g., at terminal 104, device 102—e.g., a smartphone, etc. executing identifier input application 292) to provide such identifier(s) (e.g., a PIN, password, etc.), and input(s) corresponding to such identifier(s) can be received. It should be understood that, in certain implementations, various aspects of block 340 can be performed by server 120, authentication engine 130 and/or account repository 140, while in other implementations such aspects can be performed by terminal 104 and/or one or more other elements/components, such as those described herein.

At block 345, the one or more identifiers (e.g., those received at block 340) can be authenticated, e.g., with respect to the user account (e.g., credit card number, bank account, etc.) in relation to which the transaction/request was initiated. For example, as noted, above, a user can register, define, etc. a password, PIN, etc. with respect to a user account (e.g., upon setting up the user account, upon associating ⁻various devices with the user account, etc.) and such a password, PIN, etc. can be stored with the account (e.g., in account repository 140). Accordingly, upon receiving identifier inputs (e.g., at block 340, such as the user inputting a password, PIN, etc., in an attempt to verify a transaction), such identifier inputs can be compared to the stored password, PIN, etc. in order to authenticate the identifier input(s). Upon determining that the identifier input(s) match or correspond to the stored password, PIN, etc., the transaction can be authenticated/verified for approval. It should be understood that, in certain implementations, various aspects of block 345 can be performed by server 120, authentication engine 130 and/or account repository 140, while in other implementations such aspects can be performed by terminal 104 and/or one or more other elements/components, such as those described herein.

At block 350, it can be determined whether the various transaction completion criteria (e.g., those associated with the user account, such as can be identified at block 320) are met. In certain implementations, such a determination can be made with respect to a first and second device (e.g., devices with respect to which the transaction request has been initiated, such as devices 102A and 102B as shown in FIG. 1) and the transaction request (e.g., various transaction parameters such as item(s) being purchased, purchase price, identity of the retailer, location of the retailer, time of the purchase, etc.). For example, as described above, it can be determined with respect to a transaction request whether a minimum quantity of devices associated with the user account (e.g., three wearable devices that have been registered/associated with a credit card) have been presented/perceived in conjunction with a received transaction request. Additionally, it can be further determined (with respect to the transaction request) whether all other transaction completion criteria have been met (e.g., whether the purchase is below a defined monetary threshold and is associated with a merchant and/or item that is approved for purchase). Moreover, in certain implementations it can be further determined whether the necessary authorization approval(s) have been received (e.g., from another device, such as is described with respect to blocks 325 and 330) and/or whether various identifier(s) have been received and/or authenticated (e.g., as is described with respect to blocks 335-345). It should be understood that, in certain implementations, various aspects of block 350 can be performed by server 120, authentication engine 130 and/or account repository 140, while in other implementations such aspects can be performed by terminal 104 and/or one or more other elements/components, such as those described herein.

At block 355, the transaction request (e.g., the request received at block 315) can be completed/executed. In certain implementations, such a transaction request can be completed based on/in response to a determination that the various transaction completion criteria (e.g., those associated with the user account, such as can be identified at block 320) have been met/satisfied. For example, the transaction request can be completed based on/in response to a determination that the various transaction completion criteria have been met/satisfied with respect to a first and second device (e.g., devices with respect to which the transaction request has been initiated, such as devices 102A and 102B as shown in FIG. 1). Additionally, in certain implementations the transaction request can be completed based on/in response to a determination that the various transaction completion criteria have been met/satisfied with respect to the transaction request itself. For example, the transaction request can be completed based on/in response to a determination that the various transaction completion criteria have been met/satisfied with respect to various transaction parameters such as item(s) being purchased, purchase price, identity of the retailer, location of the retailer, time of the purchase, etc. Additionally, in certain implementations such a transaction request can be completed based on/in response to receipt (e.g., at block 330) of an authorization approval (e.g., from another device, e.g., device 102C, such as in a scenario in which a ‘parent’ device authorizes transactions initiated with respect to devices associated with a ‘child’). Moreover, in certain implementations such a transaction request can be completed based on/in response to authentication (e.g., at block 345) of various identifier(s) with respect to the user account. In completing/executing such a transaction request, an approval message, transmission, etc., can be generated and transmitted, e.g., to terminal 104 (e.g., a POS terminal), indicating that the transaction has been approved. Additionally, funds, credits, etc., can be transferred from the user account to an account associated with the merchant/retailer in accordance with the terms of the transaction. It should be noted that, in scenarios in which such transaction completion criteria are not met, authorization approval(s) are not received, and/or identifiers are not authenticated, such a transaction can be canceled and/or held (e.g., until such criteria, etc. are met). Additionally, it should be understood that, in certain implementations, various aspects of block 355 can be performed by server 120, authentication engine 130 and/or account repository 140, while in other implementations such aspects can be performed by terminal 104 and/or one or more other elements/components, such as those described herein.

It should also be noted that while the technologies described herein are illustrated primarily with respect to multi-device authentication, the described technologies can also be implemented in any number of additional or alternative settings or contexts and towards any number of additional objectives. It should be understood that further technical advantages, solutions, and/or improvements (beyond those described and/or referenced herein) can be enabled as a result of such implementations.

FIG. 4 depicts an illustrative computer system within which a set of instructions, for causing the machine to perform any one or more of the methodologies discussed herein, can be executed. In alternative implementations, the machine can be connected (e.g., networked) to other machines in a LAN, an intranet, an extranet, or the Internet. The machine can operate in the capacity of a server in client-server network environment. The machine can be a computing device integrated within and/or in communication with a vehicle, a personal computer (PC), a set-top box (STB), a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 400 includes a processing system (processor) 402, a main memory 404 (e.g., read-only memory (ROM), flash memory, dynamic random access memory (DRAM) such as synchronous DRAM (SDRAM)), a static memory 406 (e.g., flash memory, static random access memory (SRAM)), and a data storage device 416, which communicate with each other via a bus 408.

Processor 402 represents one or more processing devices such as a microprocessor, central processing unit, or the like. More particularly, the processor 402 can be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processor 402 can also be one or more special-purpose processing devices such as an application specific integrated circuit (ASIC), a field programmable gate array (FPGA), a digital signal processor (DSP), network processor, or the like. The processor 402 is configured to execute instructions 426 for performing the operations discussed herein.

The computer system 400 can further include a network interface device 422. The computer system 400 also can include a video display unit 410 (e.g., a liquid crystal display (LCD) or a cathode ray tube (CRT)), an alphanumeric input device 412. (e.g., a keyboard), a cursor control device 414 (e.g., a mouse), and a signal generation device 420 (e.g., a speaker).

The data storage device 416 can include a computer-readable medium 424 on which is stored one or more sets of instructions 426 which can embody any one or more of the methodologies or functions described herein. Instructions 426 can also reside, completely or at least partially, within the main memory 404 and/or within the processor 402 during execution thereof by the computer system 400, the main memory 404 and the processor 402 also constituting computer-readable media. Instructions 426 can further be transmitted or received over a network via the network interface device 422.

While the computer-readable storage medium 424 is shown in an exemplary embodiment to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methodologies of the present disclosure. The term “computer-readable storage medium” shall accordingly be taken to include, but not be limited to, solid-state memories, optical media, and magnetic media.

In the above description, numerous details are set forth. It will be apparent, however, to one of ordinary skill in the art having the benefit of this disclosure, that embodiments can be practiced without these specific details. In some instances, structures and devices are shown in block diagram form, rather than in detail, in order to avoid obscuring the description.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “receiving,” “processing,” “providing,” “identifying,” or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

Aspects and implementations of the disclosure also relate to an apparatus for performing the operations herein which can also include a computer program stored and/or executed by the apparatus. Such a computer program can be stored in a computer readable storage medium, such as, but not limited to, any type of disk including floppy disks, optical disks, CD-ROMs, and magnetic-optical disks, read-only memories (ROMs), random access memories (RAMS), EPROMs, EEPROMs, magnetic or optical cards, or any type of media suitable for storing electronic instructions.

It should be understood that the present disclosure is not described with reference to any particular programming language. It will be appreciated that a variety of programming languages can be used to implement the teachings of the disclosure as described herein.

It is to be understood that the above description is intended to be illustrative, and not restrictive. Many other embodiments will be apparent to those of skill in the art upon reading and understanding the above description. Moreover, the techniques described above could be applied to practically any type of data. The scope of the disclosure should, therefore, be determined with reference to the appended claims, along with the full scope of equivalents to which such claims are entitled.

1. A method comprising:
receiving a transaction request from a terminal device, at a processing device, initiated with respect to a first device, a second device, and a third device associated with a user account, the second device being a non-electronic device worn by a user;
retrieving, from an account repository stored on a storage device, one or more transaction completion criteria associated with the user account for the transaction request, the transaction completion criteria indicating that at least three devices are required to be present for the user based on the transaction request exceeding an amount threshold;
receiving, as part of the transaction request, an image of the second device captured by the terminal device;
determining, by the processing device, whether the one or more transaction completion criteria associated with the user account are met with respect to the first device, the second device, a third device, and the transaction request wherein the determining includes:
determining that the second device is associated with the user account based on the captured image of the second device and a stored image of the second device as previously associated with the user account in the account repository; and
based on a determination that the one or more transaction completion criteria associated with the user account are met with respect to the first device, the second device, third device, and the transaction request, approving the transaction request.

2. The method of claim 1, further comprising:
associating the first device with the user account; and
associating the second device with the user account, the associating including storing the image of the second device in the account repository.

3. The method of claim 1, wherein the transaction completion criteria comprises a quantity of devices present during initiation of the transaction request.

4. The method of claim 1, wherein the transaction completion criteria comprises a geographic proximity between the first device and the second device.

5. The method of claim 4, wherein determining whether the one or more transaction completion criteria associated with the user account are met comprises determining a location of the third device.

6. (canceled)

7. The method of claim 1, wherein the transaction completion criteria comprises a transaction type.

8. The method of claim 1, further comprising:
transmitting an authorization request to the first device based on the one or more transaction completion criteria; and
receiving an authorization approval in response to the authorization request.

9. The method of claim 8, wherein approving the transaction request comprises approving the transaction request further based on receipt of the authorization approval.

10.-11. (canceled)

12. The method of claim 1, further comprising requesting the image of the second device based on a quantity of devices present during initiation of the transaction request.

13. A system comprising:
a processing device; and
a memory coupled to the processing device and storing instructions that, when executed by the processing device, cause the system to perform operations comprising:
receiving a transaction request from a terminal device, initiated with respect to a first device, a second device, and a third device associated with a user account, the second device being a non-electronic device worn by a user;
retrieving, from an account repository stored on a storage device, one or more transaction completion criteria associated with the user account for the transaction request, the transaction completion criteria indicating that at least three devices are required to be present for the user based on the transaction request exceeding an amount threshold;
receiving, as part of the transaction request, an image of the second device captured by the terminal device;
determining whether the one or more transaction completion criteria associated with the user account are met with respect to the first device, the second device, a third device, and the transaction request wherein the determining includes:
determining that the second device is associated with the user account based on the captured image of the second device and a stored image of the second device as previously associated with the user account in the account repository; and
based on a determination that the one or more transaction completion criteria associated with the user account are met with respect to the first device, the second device, third device, and the transaction request, approving the transaction request.

14. The system of claim 13, wherein the transaction completion criteria comprises a geographic proximity between the first device and the second device and wherein determining whether the one or more transaction completion criteria associated with the user account are met comprises determining a location of the third device.

15. The system of claim 13, wherein the memory further stores instructions for causing the system to perform operations comprising:
transmitting an authorization request to the first device based on the one or more transaction completion criteria; and
receiving an authorization approval in response to the authorization request;
wherein approving the transaction request comprises approving the transaction request further based on receipt of the authorization approval.

16.-17. (canceled)

18. The system of claim 13, wherein the memory further stores instructions for causing the system to perform operations comprising:
requesting the image of the second device based on a quantity of devices present during initiation of the transaction request.

19. A non-transitory computer readable medium having instructions stored thereon that, when executed by a processing device, cause the processing device to perform operations comprising:
receiving a transaction request from a terminal device, initiated with respect to a first device, a second device, and a third device associated with a user account, the second device being a non-electronic device worn by a user;
retrieving, from an account repository stored on a storage device, one or more transaction completion criteria associated with the user account for the transaction request, the transaction completion criteria indicating that at least three devices are required to be present for the user based on the transaction request exceeding an amount threshold;
receiving, as part of the transaction request, an image of the second device captured by the terminal device;
determining whether the one or more transaction completion criteria associated with the user account are met with respect to the first device, the second device, a third device, and the transaction request wherein the determining includes:
determining that the second device is associated with the user account based on the captured image of the second device and a stored image of the second device as previously associated with the user account in the account repository; and
based on a determination that the one or more transaction completion criteria associated with the user account are met with respect to the first device, the second device, the third device, and the transaction request, approving the transaction request.

20. The computer-readable medium of claim 19, wherein the transaction completion criteria comprises a geographic proximity between the first device and the second device and wherein determining whether the one or more transaction completion criteria associated with the user account are met comprises determining a location of the third device.

21. The computer-readable medium of claim 19, wherein the medium further stores instructions for causing the processing device to perform operations comprising:
transmitting an authorization request to the first device based on the one or more transaction completion criteria; and
receiving an authorization approval in response to the authorization request;
wherein approving the transaction request comprises approving the transaction request further based on receipt of the authorization approval.

22.-23. (canceled)

24. The computer-readable medium of claim 19, wherein the medium further stores instructions for causing the processing device to perform operations comprising:
requesting the image of the second device based on a quantity of devices present during initiation of the transaction request.
